(19) United States
(12) Patent Application Publication
(10) Pub. No.: US 2011/0078006 A1
(43) Pub. Date: Mar. 31, 2011

(54) MODULAR COUPONS IN TRAIL-OF-BREADCRUMBS ADVERTISING

(75) Inventor: Donald Gene ARCHER, Euless, TX (US)

(73) Assignee: Verizon Patent and Licensing Inc., Basking Ridge, NJ (US)

(21) Appl. No.: 12/570,216

(22) Filed: Sep. 30, 2009

(51) Int. Cl. G06Q 30/00

(52) U.S. Cl. 705/14.23

(57) ABSTRACT

A system facilitates provision of a first advertisement, including a first modular coupon, via a first network to a user, where the first advertisement provides a link to a second advertisement. The system further facilitates provision of the second advertisement, including a second modular coupon, via a second network to the user, where the second network is different than the first network. The system also receives the first and second modular coupons from the user and permits a discount associated with the user's purchase of a product or service based on receipt of the first and second modular coupons.

### BACKGROUND

Advertising is a form of communication used to help sell products and/or services. Typically, advertising communicates a message that includes a name of the product and/or service and some reason how that product and/or service would benefit, or otherwise be desirable to, the consumer. On-line advertising systems host advertisements that may advertise various products and/or services. Such advertisements may typically be presented to users accessing documents hosted by the advertising system, or to users issuing search queries for searching a corpus of documents.

### BRIEF DESCRIPTION OF THE DRAWINGS

FIG. 1 is a diagram of an overview of the issuance of modular coupons in a “trail-of-breadcrumbs” advertising campaign according to an exemplary embodiment;

FIG. 2A is a diagram of a network in which multiple media delivery networks and media presentation devices may be used to conduct the “trail-of-breadcrumbs” advertising campaign depicted in FIG. 1;

FIG. 2B is a diagram of a specific example of the network of FIG. 2A in which a Public Switched Telephone Network (PSTN), a wireless network, an Internet, and an optical network may deliver “trail-of-breadcrumbs” advertising to a respective Plain Old Telephone System (POTS) phone, a cellular phone, a computer and a set-top box associated with a television;

FIG. 3 depicts media delivery to the exemplary media delivery devices of FIG. 2B;

FIG. 4 is a diagram of a device, according to an exemplary implementation, that may include the ad/coupon server of FIG. 2A;

FIG. 5 is a flow diagram that illustrates an exemplary process for providing “trail-of-breadcrumbs” advertising to a user;

FIG. 6 depicts the provision of a text message, which includes a breadcrumb and a multi-stage coupon, to a cellular telephone via a wireless network;

FIG. 7 depicts the provision of an audio recording, which includes a breadcrumb and a multi-stage coupon, to a POTS telephone via a PSTN;

FIG. 8 depicts the provision of television audio, video or text, which includes a breadcrumb and a multi-stage coupon, to a set top box (STB) associated with a television; and

FIG. 9 depicts the provision of a webpage to a computer via the Internet for user entry of previously obtained multi-stage coupons.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

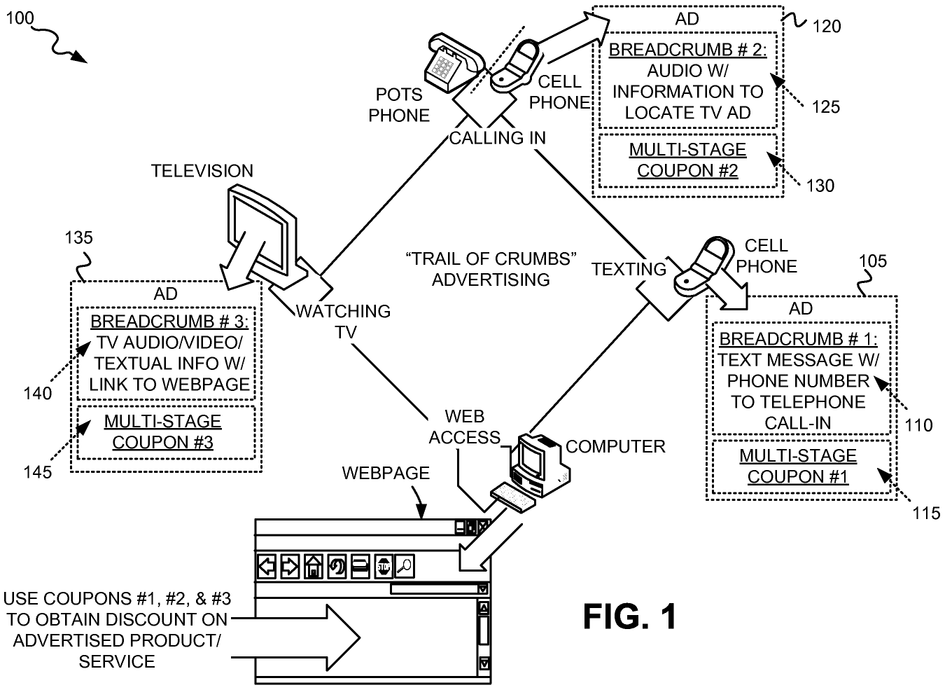

FIG. 1 is a diagram of an overview 100 of the issuance of modular coupons in a “trail-of-breadcrumbs” advertising campaign according to an exemplary embodiment. A “trail-of-breadcrumbs” advertising campaign, as shown in FIG. 1, may involve the delivery of a series of advertisements to a user via multiple different media delivery networks and via respective, different media presentation devices. Each of the advertisements in the series of advertisements may include a “breadcrumb” that the user may follow to receive a subsequent advertisement, possibly via a different media delivery network and media presentation device. Each of the advertisements in the series of advertisements may further include a multi-stage, modular coupon. As the user progresses through each stage of the “trail-of-breadcrumbs” advertising campaign, the user may collect each modular coupon of the multi-stage modular coupons. The collected coupons may be used to purchase a product or service at a discount at the end of the “trail-of-breadcrumbs” advertising campaign or, possibly, at some intermediate stage in the “trail-of-breadcrumbs” advertising campaign. The amount of the discount may, in some implementations, depend on the number of multi-stage coupons collected by the user (i.e., how far the user progressed in the “trail-of-breadcrumbs” advertising campaign).

FIG. 1 depicts one example of a “trail-of-breadcrumbs” advertising campaign in which advertisements, including multi-stage coupons, are provided to a user via the user's cell phone, POTS phone, television and/or computer. As shown in FIG. 1, a text message may initially be sent to the user via the user's cell phone. The text message may include an advertisement 105 which further includes a first breadcrumb 110 and a first multi-stage coupon 115. Breadcrumb 110 may include a text message that further includes a phone number to a telephone call-in center. Multi-stage coupon 115 may include a first modular coupon in a series of modular coupons. The first modular coupon may include, for example, a first portion of a code (e.g., a portion of the digits of the code).

The user may “follow” breadcrumb 110 by using the received phone number to call in to a call-in center that may provide an advertisement 120 as a pre-recorded audio message. The user may, for example, use a POTS phone or cell phone to receive the pre-recorded audio message. Advertisement 120 may include a second breadcrumb 125 and a second multi-stage coupon 130. Breadcrumb 125 may include a pre-recorded audio message which may include audio information that enables the user to locate a television (TV) advertisement. Such information may include, for example, a day and time during which the advertisement may be broadcast on a certain channel. Such information may alternatively include information directing the user to turn on their STB and TV so that the advertisement may be shown (i.e., pre-empting regular television programming during the duration of the advertisement). Multi-stage coupon 130 may include a second modular coupon. The modular coupon may include, for example, a second portion of a code (e.g., a portion of the digits of the code).

The user may then “follow” breadcrumb 125 by watching the user's television. The user may use the user's STB and television to watch an advertisement 135. Advertisement 135 may include a breadcrumb 140 and a multi-stage coupon 145. Breadcrumb 140 may include television audio, video and/or textual information that may further include information that will enable the user to access a webpage hosted on the Internet. For example, breadcrumb 140 may include a Uniform Resource Locator (URL) associate with the webpage. Multi-stage coupon 145 may include a third modular coupon in the series of modular coupons. The third modular coupon may include, for example, a third portion of a code (e.g., a portion of the digits of the code).

The user may then further “follow” breadcrumb 140 to access the webpage via the user's computer. The webpage may, for example, enable the user to use coupons 115, 130 and 145 to obtain a discount on a product and/or service. Thus, to obtain the discount for the product and/or service the user must progress through the “trail-of-breadcrumbs” advertising campaign obtaining each multi-stage coupon, and then entering each multi-stage coupon into the webpage to receive the discount. For example, the web page may include multiple entry fields for each portion of a code that corresponds to each multi-stage coupon 115, 130 and 145.

The number of “breadcrumbs” and multi-stage coupons, and the number and types of media delivery devices, depicted in FIG. 1 is for illustrative purposes only. Fewer, or more, breadcrumbs and multi-stage coupons, and different numbers and types of media delivery devices, may be used consistent with exemplary embodiments described herein.

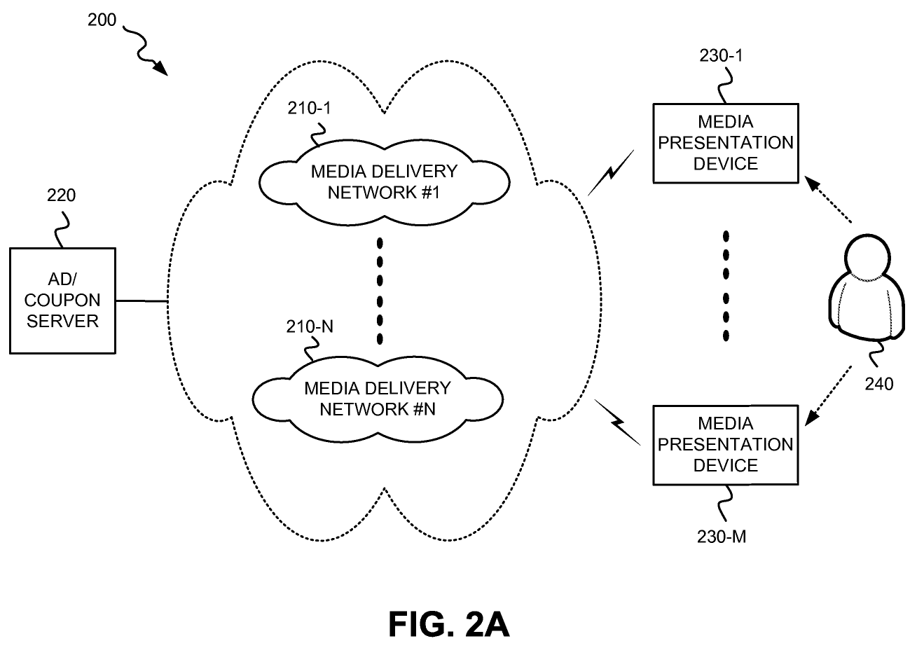

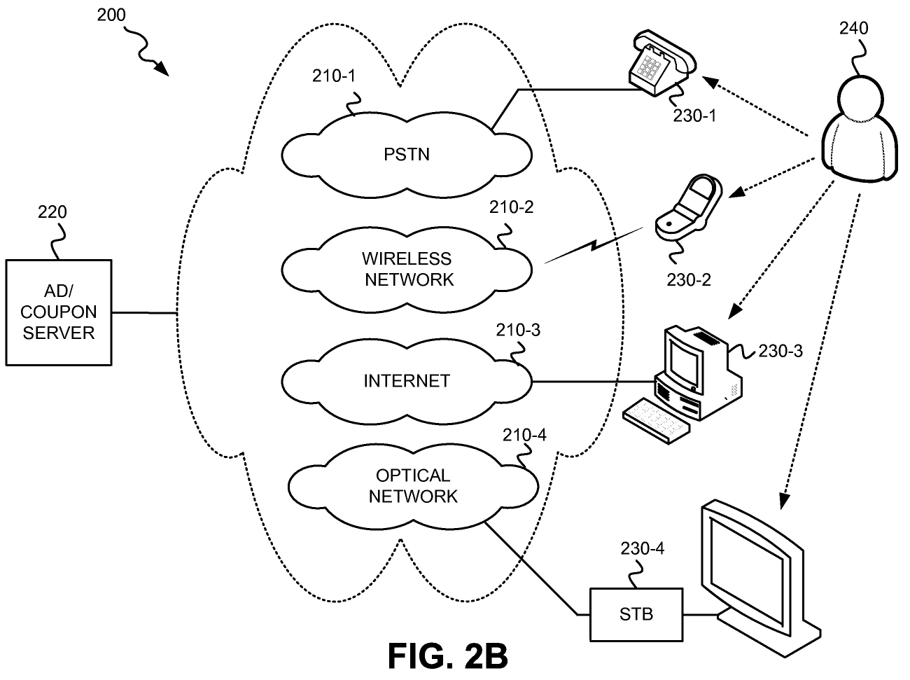

FIG. 2A is a diagram of a network 200 in which multiple media delivery networks and media presentation devices may be used to conduct the exemplary “trail-of-breadcrumbs” advertising campaign depicted in FIG. 1 (or other “trail-of-breadcrumbs” campaigns that are different than that shown in FIG. 1). As shown in FIG. 2A, network 200 may include multiple media delivery networks 210-1 through 210-N which may serve to deliver media between an ad/coupon server 220 and multiple different media presentation devices 230-1 through 230-M associated with a user 240. Ad/coupon server 220 may include a server entity that may provide, alone or possibly in conjunction with other devices (not shown), advertising media via media delivery networks 210-1 through 210-N to media presentation devices 230-1 through 230-M. Each of media delivery networks 210-1 through 210-N may include a different type of network, and each may include, for example, one of a PSTN, a wireless network (e.g., a cellular network), the Internet, or an optical network (e.g., a cable television optical network). Other types of networks, than those described here, may, however, be used. Each of media presentation devices 230-1 through 230-M may include a different type of device for receiving advertisements and coupons via a respective network of media delivery networks 210-1 through 210-N. Media presentation devices 230-1 through 230-M may include (but are not limited to) POTS phones, cellular phones, computers, and STBs in conjunction with televisions. FIG. 2B below depicts examples of specific types of media presentation devices.

FIG. 2B depicts examples of media presentation devices 230 that may be used by user 240 to receive the “trail-of-breadcrumbs” advertising campaign. As shown in FIG. 2B, the media delivery networks 210 of network 200 may include a PSTN 210-1, a wireless network 210-2, the Internet 210-3 and an optical network 210-4 (e.g., a cable television optical network). Media presentation devices 230 may include a POTS phone 230-1, a cellular phone 230-2, a computer 230-3, and a set-top box (STB) connected to a television (TV). As shown, PSTN 210-1 may connect to POTS phone 230-1, wireless network 210-2 may connect to cellular phone 230-2, Internet 210-3 may connect to computer 230-3, and optical network 210-4 may connect STB 230-4. Each of POTS phone 230-1, cellular phone 230-2, computer 230-3 and STB 230-4 may be associated with a same user 240.

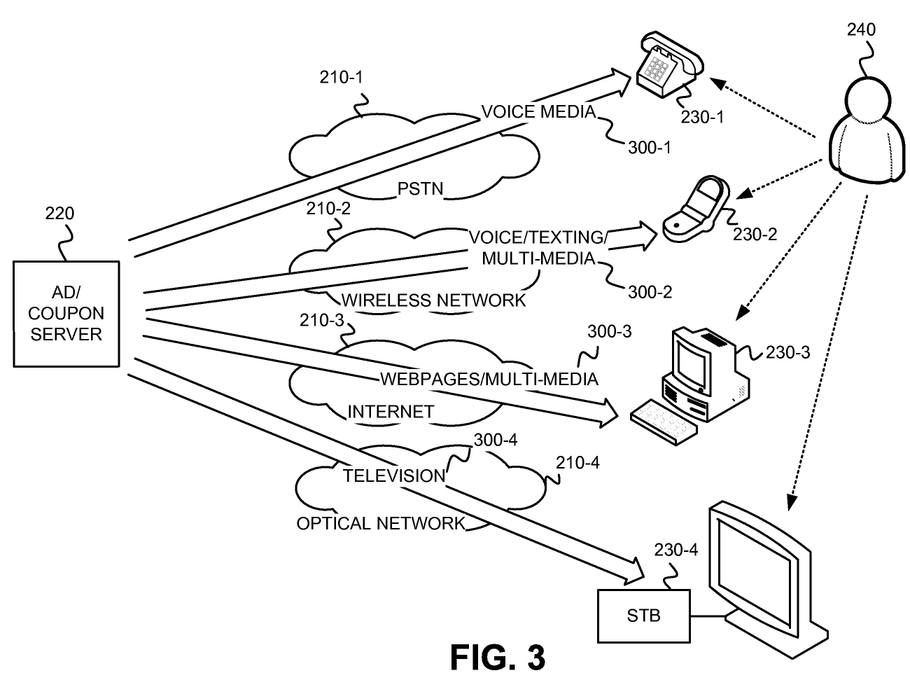

FIG. 3 further graphically depicts media delivery, associated with the “trail-of-breadcrumbs” advertising campaign, to the exemplary media delivery devices of FIG. 2B. As illustrated, ad/coupon server 220, either alone or in conjunction with other devices (not shown), may send voice media 300-1 to POTS phone 230-1 via PSTN 210-1. Ad/coupon server 220, either alone or in conjunction with other devices, may send voice/text/multi-media data 300-2 to cellular phone 230-2 via wireless network 210-2. Ad/coupon server 220, either alone or in conjunction with other devices, may send webpages/multi-media 300-3, to computer 230-3 via Internet 210-3. Ad/coupon server 220, either alone or in conjunction with other devices, may transmit television data 300-4 to STB 230-4 via optical network 210-4. Each of the different types of media delivered to media presentation devices 230-1 through 230-4 may include an advertisement that further includes a breadcrumb and a modular coupon. Each breadcrumb may direct the user to a subsequent advertisement, breadcrumb and multi-stage coupon. The modular coupon may include a coupon in a series of the “trail-of-breadcrumbs” advertising campaign.

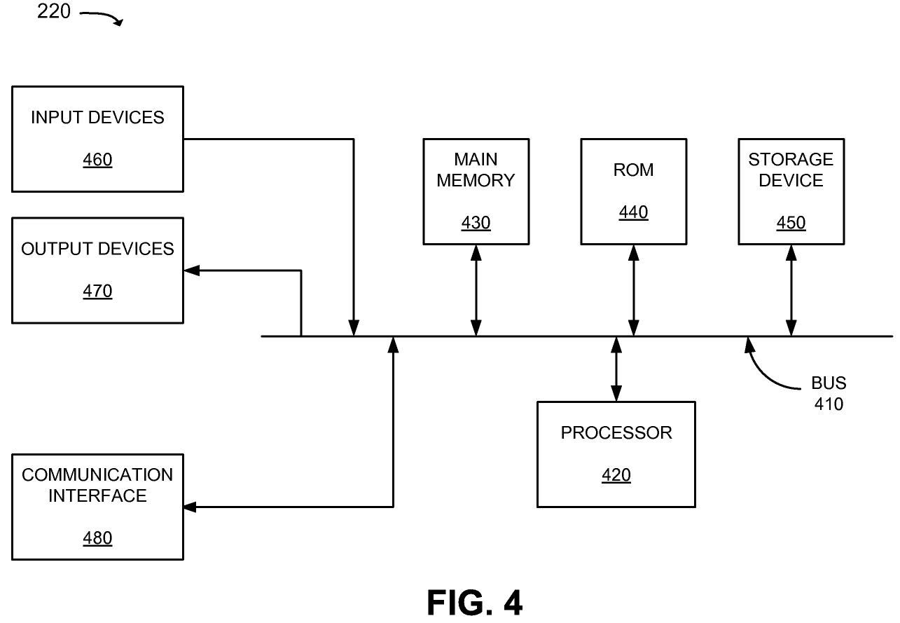

FIG. 4 is a diagram of ad/coupon server 220 according to an exemplary implementation. Server 220 may include a bus 410, a processor 420, a main memory 430, a read only memory (ROM) 440, a storage device 450, input device(s) 460, output device(s) 470, and a communication interface 480. Bus 410 may include a path that permits communication among the elements of server 220.

Processor 420 may include, for example, a processor, microprocessor, and/or processing logic that may interpret and execute instructions. In some implementations, processor 420 may include multiple processors (e.g., parallel processors). Main memory 430 may include a random access memory (RAM) or another type of dynamic storage device that may store information and instructions for execution by processor 420. ROM 440 may include a ROM device or another type of static storage device that may store static information and instructions for use by processor 420. Storage device 450 may include a magnetic and/or optical recording medium and its corresponding drive.

Input device(s) 460 may include one or more mechanisms that permit an operator to input information to server 220, such as a keyboard, a mouse, a pen, voice recognition and/or biometric mechanisms, etc. Output device(s) 270 may include one or more mechanisms that output information to the operator, including a display, a printer, a speaker, etc. Communication interface 280 may include any transceiver-like mechanism that enables server 220 to communicate with other devices and/or systems. For example, communication interface 280 may include mechanisms for communicating with another device or system via network 200.

Server 220 may perform certain operations or processes, as will be described in detail below. Server 220 may perform these operations in response to processor 420 executing software instructions contained in a computer-readable medium, such as memory 430. A computer-readable medium may be defined as a physical or logical memory device. A logical memory device may include memory space within a single physical memory device or spread across multiple physical memory devices.

The software instructions may be read into memory 430 from another computer-readable medium, such as storage device 450, or from another device via communication interface 480. The software instructions contained in memory 430 may cause processor 420 to perform operations or processes that will be described later. Alternatively, hardwired circuitry may be used in place of or in combination with software instructions to implement processes consistent with the principles of the invention. Thus, exemplary implementations are not limited to any specific combination of hardware circuitry and software.

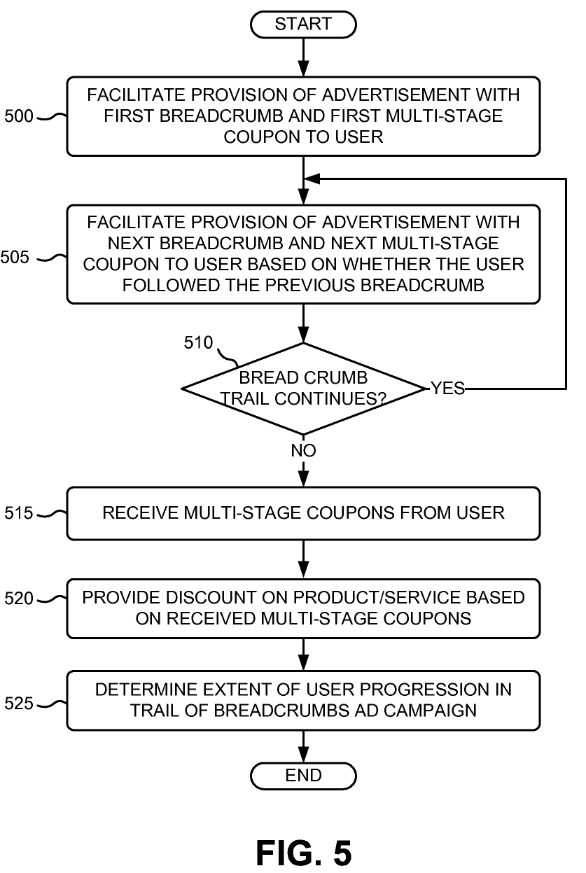

FIG. 5 is a flow diagram illustrating an exemplary process for providing “trail-of-breadcrumbs” advertising to a user. The exemplary process of FIG. 5 may be implemented by ad/coupon server 220, either alone or in conjunction with other devices.

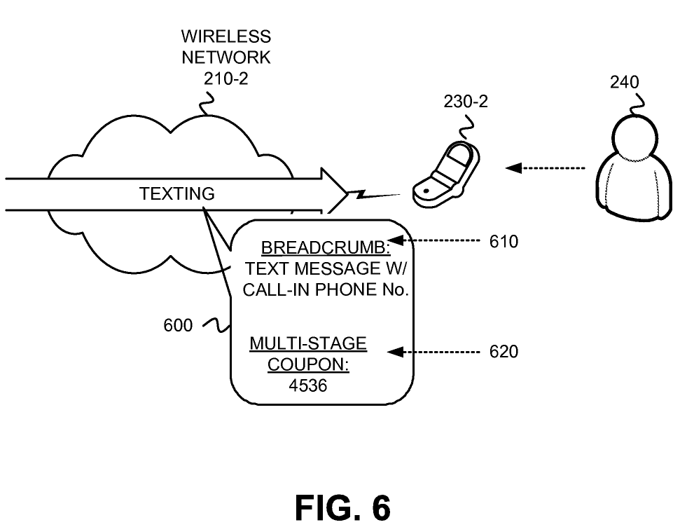

The exemplary process of FIG. 5 may begin with facilitating the provision of an advertisement with a first breadcrumb and a first multi-stage coupon to user 240 (block 500). For example, as shown in the example of FIG. 6, a text message advertisement 600 may be sent to user 240's cellular phone 230-2 via wireless network 210-2. Advertisement 600 may include a breadcrumb 610 and a multi-stage coupon 620. Advertisement 600 may additionally include information (not shown) about a given product or service. Breadcrumb 610 may include a text message with a call-in center phone number. Multi-stage coupon 620 may include a portion of a coupon code (e.g., “code 4536” depicted by way of example) that may eventually be used, in conjunction with other codes associated with other multi-stage coupons in the “trail-of-breadcrumbs” advertising campaign, to obtain a product/service discount.

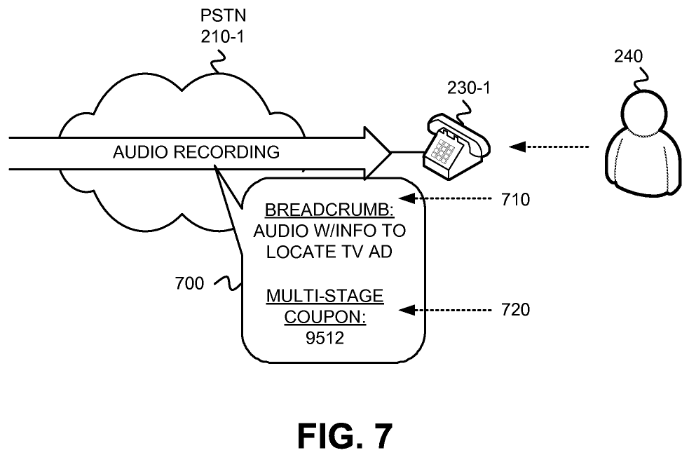

The provision of an advertisement with a next breadcrumb and a next multi-stage coupon to the user may be facilitated based on whether the user followed the previous breadcrumb (block 505). For example, referring back to the example of FIG. 6, user 240 may follow breadcrumb 610 by calling the call-in phone number to receive a pre-recorded audio message, as further illustrated in FIG. 7. As shown, an audio recording advertisement 700 may be sent to user 240's POTS phone 230-1 via PSTN 210-1. Advertisement 700 may include a breadcrumb 710 and a multi-stage coupon 720. Advertisement 700 may additionally include information (not shown) about a given product or service. Breadcrumb 710 may include an audio message with information to locate a television advertisement. Such information may include, for example, a day, time and channel at which a next advertisement in the “trail-of-breadcrumbs” advertising campaign may be provided. Multi-stage coupon 720 may include a portion of a coupon code (e.g., “code 9512” depicted in FIG. 7) that may eventually be used, in conjunction with other codes associated with other multi-stage coupons in the “trail-of-breadcrumbs” advertising campaign, to obtain a product/service discount.

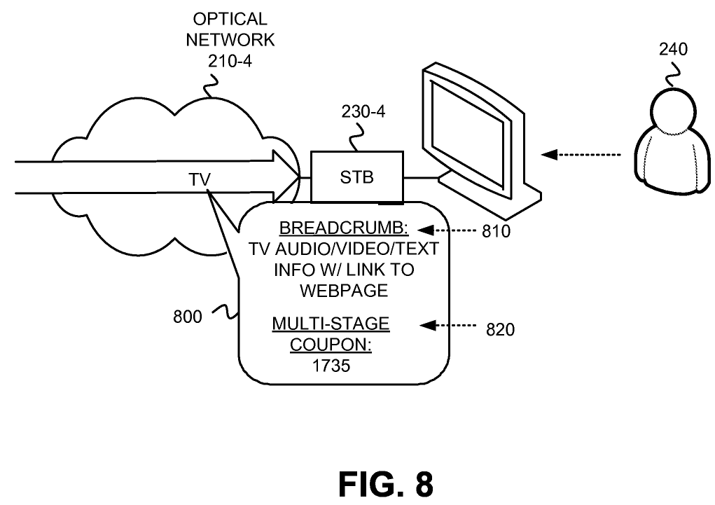

It may be determined if the breadcrumb trail continues (block 505). The “trail-of-breadcrumbs” advertising campaign may include a series of multiple advertisements (e.g. two or more), each having a breadcrumb and a multi-stage coupon. If the breadcrumb trail continues (YES-block 510), then the exemplary process may return to block 505. Blocks 505 and 510 may be selectively repeated for each advertisement, breadcrumb and multi-stage coupon in the “trail-of-breadcrumbs” advertising campaign. Referring back to the example of FIG. 7, user 420 may follow breadcrumb 710 by tuning his/her television to the proper channel at the proper day and time to receive television audio, video and/or text information that includes a link to a webpage. As shown in FIG. 8, the television audio, video and/or text information may be sent to user 240's STB 230-4 via optical network 210-4 for display on a television. Advertisement 800 may include a breadcrumb 810 and a multi-stage coupon 820. Advertisement 800 may additionally include information (not shown) about a given product or service. Breadcrumb 810 may include audio, video and/or textual information that includes a link to a webpage in Internet 210-3. The link may include, for example, a URL of the webpage. Multi-stage coupon 820 may include a portion of a coupon code (e.g., “code 1735” depicted in FIG. 8) that may eventually be used, in conjunction with other codes associated with other multi-stage coupons in the “trail-of-breadcrumbs” advertising campaign, to obtain a product/service discount.

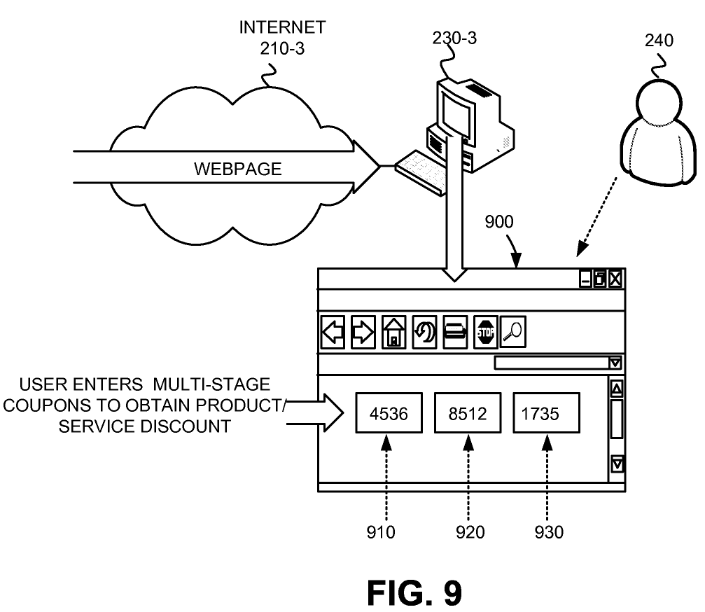

Returning to block 510, if the breadcrumb trail does not continue (NO-block 510), then the multi-stage coupons may be received from the user (block 515). Referring back to the example of FIG. 8, user 240 may follow the last breadcrumb 810 to webpage 900, as shown in FIG. 9. As shown, webpage 900 may be sent to user 240's computer 230-3. Upon receipt of webpage 900, user 240 may enter the previously received coupons 620, 720 and 820 as codes in respective fields 910, 920 and 930 in webpage 900. In a situation where the multi-stage coupons are not received from the user, the exemplary process may end without provision of the discount to the user.

A discount on a product or service may be provided to the user based on the one or more received multi-stage coupons (block 520). The amount of the discount may, in some implementations, depend on the number of multi-stage coupons collected by the user (i.e., how far the user progressed in the “trail-of-breadcrumbs” advertising campaign). In other implementations, a discount may only be provided if the user progressed through the entire “trail-of-breadcrumbs” advertising campaign and supplied the codes associated with all of the multi-stage coupons. The discount may be provided to the user, for example, at the time that the user “checks out” when purchasing a product and/or service on-line. When “checking-out,” the user may enter the codes associated with the multi-stage coupons to have the discount subtracted from the total cost of the user's on-line order.

An extent of user progression in the trail of breadcrumbs ad campaign may be determined (block 525). Ad/coupon server 220, either alone or in conjunction with other devices, may keep a record of user 240's progress through the “trail-of-breadcrumbs” advertising campaign. Ad/coupon server 220 may further determine which advertisement media delivery transitions are the most effective. The advertisement transitions may include, for example, an advertisement and breadcrumb sent to the user via a wireless network followed by the transition to an advertisement and breadcrumb sent to the user via a cable television optical network. Ad/coupon server 220 may analyze whether the user follows each provided breadcrumb to determine which media delivery transitions are the most effective. The analysis may include, for example, the determination of a “drop-off” percentage for each stage of the “trail-of-breadcrumbs” advertising campaign. For example, the analysis may determine that X % of users fail to continue to follow the “trail-of-breadcrumbs” when the trail leads from access to media via a cellular phone to access to media via a POTS phone. As another example, the analysis may determine that Y % of users fail to continue to the follow the “trail-of-breadcrumbs” when the trail leads from access to media via a POTS phone to access to media via a STB and television.

The exemplary process of FIG. 5 may be selectively repeated for each user who chooses to follow a “trail-of-breadcrumbs” advertising campaign by receiving advertisements, breadcrumbs, and coupons at multiple media presentation devices 230-1 through 230-M.

Exemplary embodiments described herein may enable “trail-of-breadcrumbs” advertising campaigns to be conducted that involve providing a series of advertisements to a user via multiple different media delivery networks and via respective, different media presentation devices. Each of the advertisements in the series of advertisements may include a “breadcrumb” that the user may follow to receive a subsequent advertisement, possibly via a different media delivery network and media presentation device, where the advertisement may further include a multi-stage, modular coupon. The user may collect each modular coupon of the multi-stage modular coupons as the user progresses through each stage of the “trail-of-breadcrumbs.” The collected coupons may subsequently be used to purchase a product or service at a discount at some point in the “trail-of-breadcrumbs” (e.g., at the end, or at some intermediate stage).

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIG. 5, the order of the blocks may be modified in other implementations consistent with the principles of the invention. Further, non-dependent blocks may be performed in parallel.

Variations of exemplary embodiments described herein may include a capability of the user to opt-in or opt-out of “trail-of-breadcrumb” advertising. Variations of exemplary embodiments may additionally include enabling the user to set ad preferences and/or to join particular advertising campaigns.

It will be apparent that embodiments, as described above, may be implemented in many different forms of software, firmware, and hardware in the implementations illustrated in the figures. The actual software code or specialized control hardware used to implement embodiments is not limiting of the invention. Thus, the operation and behavior of the embodiments have been described without reference to the specific software code, it being understood that software and control hardware may be designed based on the description herein.

Further, certain portions of the invention may be implemented as “logic” that performs one or more functions. This logic may include hardware, such as an application specific integrated circuit or a field programmable gate array, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method implemented in a device coupled to first and second networks, comprising:
facilitating, via a processor of the device, provision of a first advertisement, including a first modular coupon, via the first network to a user, where the first advertisement provides a link to a second advertisement;
facilitating, via the processor, provision of the second advertisement, including a second modular coupon, via the second network to the user, where the second network is different than the first network;
receiving, via a communication interface, the first and second modular coupons from the user; and
permitting a discount associated with the user's purchase of a product or service based on receipt of the first and second modular coupons.

2. The method of claim 1, where the first modular coupon includes a first code and the second modular coupon includes a second, different code and where receiving the first and second modular coupons comprises received the first and second codes from the user.

3. The method of claim 2, where permitting the discount is further based on receipt of the first and second codes from the user.

4. The method of claim 1, where provision of the second advertisement is facilitated based on the user following the link to the second advertisement.

5. The method of claim 1, where the link directs the user to the second advertisement.

6. The method of claim 1, where the first and second networks each comprise a different one of a wireless network, a Public Switched Telephone Network (PSTN), an Internet, or an optical network.

7. The method of claim 1, where the second advertisement provides an additional link to a third advertisement and where the method further comprises:
facilitating provision of the third advertisement, including a third modular coupon, via a third network to the user, where the third network is different than the first and second networks;
receiving, in addition to the first and second modular coupons, the third modular coupon; and
permitting the discount based on receipt of the first, second and third modular coupons.

8. The method of claim 7, further comprising:
determining the user's progress through the first, second and third advertisements to evaluate advertisement effectiveness.

9. The method of claim 7, where the first, second and third networks each comprise a different one of a wireless network, a Public Switched Telephone Network (PSTN), an Internet, or an optical network.

10. The method of claim 7, where the additional link directs the user to the third advertisement.

11. The method of claim 1, where the first network comprises a wireless network and the advertisement comprises a text message.

12. The method of claim 1, where the first network comprises a Public Switched Telephone Network (PSTN) and the advertisement comprises an audio recording.

13. The method of claim 1, where the first network comprises an optical network and the advertisement comprises television audio, video and/or text.

14. The method of claim 1, where the first network comprises an Internet and the advertisement comprises a webpage.

15. A server, comprising:
a memory to store instructions; and
one or more processors to execute the instructions to:
facilitate provision of a first advertisement, including a first modular coupon, via a first network to a user, where the first advertisement provides a link to a second advertisement,
facilitate provision of the second advertisement, including a second modular coupon, via a second network to the user, where the second advertisement provides an additional link to a third advertisement,
facilitate provision of the third advertisement, including a third modular coupon, via a third network to the user, where first, second and third networks are different networks,
receive the first, second and third modular coupons from the user, and
permit a discount associated with the user's purchase of a product or service based on receipt of the first, second and third modular coupons.

16. The server of claim 15, where the first modular coupon includes a first code, the second modular coupon includes a second code, and the third modular coupon includes a third code, where the first, second and third codes are different from one another, and where, when receiving the first and second modular coupons, the one or more processors receive the first, second and third codes from the user.

17. The server of claim 16, where the one or more processors permit the discount based on receipt of the first, second and third codes from the user.

18. The server of claim 15, where provision of the second advertisement is facilitated based on the user following the link to the second advertisement and where provision of the third advertisement is based on the user following the additional link to the third advertisement.

19. The server of claim 15, where the link to the second advertisement directs the user to the second advertisement.

20. The server of claim 15, where the first, second and third networks each comprise a different one of a wireless network, a Public Switched Telephone Network (PSTN), an Internet, or an optical network.

21. A computer-readable medium containing instructions executable by at least one processor, the computer-readable medium comprising:
one or more instructions for facilitating provision of a first advertisement, including a first link and a first portion of a code, to a user via a first network, where the first link directs the user to a second advertisement;
one or more instructions for facilitating provision of a second advertisement, including a second link and a second portion of the code, to the user via a second network in response to the user following the first link, where the second link directs the user to a third advertisement;
one or more instructions for facilitating provision of the third advertisement, including a third portion of the code, to the user via a third network in response to the user following the second link;
one or more instructions for receiving the first, second and third portions of the code; and
one or more instructions for providing a discount for a product or service in response to receiving the first, second and third portions of the code.

22. The computer-readable medium of claim 21, further comprising:
one or more instructions for determining the user's progress through the first and second links to evaluate advertisement effectiveness.
